(19) United States
(12) Patent Application Publication
(10) Pub. No.: US 2014/0156416 A1
(43) Pub. Date: Jun. 5, 2014

(54) PREVIEWING, APPROVING AND TESTING ONLINE CONTENT

(71) Applicant: Google Inc., Mountain View, CA (US)

(72) Inventors: Vishal Goenka, Santa Clara, CA (US); Stephen N. Tsun, Cupertino, CA (US); David Monsees, San Francisco, CA (US); Tom Ayles, Mountain View, CA (US)

(21) Appl. No.: 13/692,700

(22) Filed: Dec. 3, 2012

(51) Int. Cl. G06Q 30/02

(52) U.S. Cl. CPC G06Q 30/0276
USPC 705/14.66

(57) ABSTRACT

Methods and systems for previewing, approving and testing online content, particularly dynamically-created content, are provided. The methods and systems described herein enable a reviewer to access an online content management system through a user interface and view a dynamically-created item of online content as it would be viewed by an online user. In addition, a reviewer is able to create and view a plurality of similar but non-identical items of dynamically-created online content, and then save the underlying build data so that the plurality of items can be regenerated together at a later time. In addition, the build data may be saved to permit it to be transmitted to a third party to enable the third party to regenerate and view the items of online content.

### BACKGROUND

This description relates to online content, and, more particularly, to a network-based method and system for previewing, approving and testing online content to ensure proper publication of the online content.

An online content management system may provide for the creation of templates for items of online content, such that certain components of an item of online content are configurable, so that they may incorporate different components or characteristics, in response to characteristics of the online users viewing the item of online content. Such components may be referred to as dynamic content. For example, an item of online content may be configured to be displayed in whatever language is the primary language of the country or region of the online viewer. Other components, such as the identification of specific products, local currency, time and the like, may be configurable based on the location or other characteristics of the online viewer.

### BRIEF DESCRIPTION OF THE DISCLOSURE

In an aspect, a computer-implemented method for previewing and approving an advertisement is provided, wherein the method is implemented using a computer device coupled to a user interface and a memory device. The method includes retrieving from the memory device a stored template for an advertisement, wherein when displayed to an online user, at least one component of the advertisement is configurable in response to at least one characteristic associated with the online user. The method further includes receiving first build data to generate a first variation of the advertisement, wherein the at least one component of the advertisement is configured in response to a first defined characteristic inputted by a reviewer. The method further includes generating the first variation of the advertisement. The method further includes receiving second build data to generate a second variation of the advertisement, wherein the at least one component of the advertisement is configured in response to a second defined characteristic inputted by the reviewer. The method further includes generating the second variation of the advertisement. The method further includes presenting to the user interface the first and second variations of the advertisement for selective display to the reviewer. The method further includes storing the first and second build data associated with the generation of the first and second variations of the advertisement to enable subsequent regeneration of the first and second variations of the advertisement.

In another aspect, computer-readable storage media having computer-executable instructions embodied thereon are provided. When executed by at least one processor, the computer-executable instructions cause the processor to retrieve from the memory device a stored template for an advertisement, wherein when displayed to an online user, at least one component of the advertisement is configurable in response to at least one characteristic associated with the online user. The computer-executable instructions further cause the processor to receive first build data to generate a first variation of the advertisement, wherein the at least one component of the advertisement is configured in response to a first defined characteristic inputted by a reviewer. The computer-executable instructions further cause the processor to generate the first variation of the advertisement. The computer-executable instructions further cause the processor to receive second build data to generate a second variation of the advertisement, wherein the at least one component of the advertisement is configured in response to a second defined characteristic inputted by a reviewer. The computer-executable instructions further cause the processor to generate the second variation of the advertisement. The computer-executable instructions further cause the processor to present to the user interface the first and second variations of the advertisement for selective display to the reviewer. The computer-executable instructions further cause the processor to store the first and second build data associated with the generation of the first and second variations of the advertisement to enable subsequent regeneration of the first and second variations of the advertisement.

In another aspect, a computer system is provided. The computer system includes a processor, and a computer-readable memory device having encoded thereon computer readable instructions that are executable by the processor. The processor is configured to retrieve from the memory device a stored template for an advertisement, wherein when displayed to an online user, at least one component of the advertisement is configurable in response to at least one characteristic associated with the online user. The processor is further configured to receive first build data to generate a first variation of the advertisement, wherein the at least one component of the advertisement is configured in response to a first defined characteristic inputted by a reviewer. The processor is further configured to generate the first variation of the advertisement. The processor is further configured to receive second build data to generate a second variation of the advertisement, wherein the at least one component of the advertisement is configured in response to a second defined characteristic inputted by the reviewer. The processor is further configured to generate the second variation of the advertisement. The processor is further configured to present to the user interface the first and second variations of the advertisement for selective display to the reviewer. The processor is further configured to store the first and second build data associated with the generation of the first and second variations of the advertisement to enable subsequent regeneration of the first and second variations of the advertisement.

The features, functions, and advantages described herein may be achieved independently in various embodiments of the present disclosure or may be combined in yet other embodiments, further details of which may be seen with reference to the following description and drawings.

### BRIEF DESCRIPTION OF THE DRAWINGS

FIG. 1 is a block diagram depicting an example advertising environment.

FIG. 2 is a diagram of an example advertising serving system shown in FIG. 1, in which an aspect of the methods and systems described herein may be employed in accordance with one embodiment of the present invention.

FIG. 3 is a flowchart of an example method implemented using the advertising server system of FIGS. 1 and 2 for enabling post-creation review of an advertisement.

FIG. 4 illustrates an example screenshot of a user interface that may be accessed by a reviewer of an advertisement in accordance with one embodiment of the present invention.

FIG. 5 is a diagram of example computing systems that may be used in the environment shown in FIG. 1 in accordance with one embodiment of the present invention.

FIG. 6 is a flowchart of an example method for re-creation of advertisement variations by a recipient of a link to an advertisement review.

Although specific features of various embodiments may be shown in some drawings and not in others, this is for convenience only. Any feature of any drawing may be referenced and/or claimed in combination with any feature of any other drawing.

### DETAILED DESCRIPTION OF THE DISCLOSURE

The following detailed description of implementations consistent with the principles of the disclosure refers to the accompanying drawings. The same reference numbers in different drawings may identify the same or similar elements. Also, the following detailed description does not limit the invention.

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

The subject matter described herein relates generally to online content and/or online advertising. Specifically, the methods and systems herein enable an advertiser to preview, approve and test online advertisements as those advertisements would appear to an online user, taking into account the viewing circumstances of the online user, such as the location of the user device, possible demographic data associated with the user, etc. The methods and systems herein specifically address the ability of an advertiser or other third party to review created dynamic advertisements, and to determine whether the dynamic advertisements are providing the correct content for the online users.

Dynamic ads (also referred to herein as “creatives”) are advertisements that are dynamically generated according to an ad template using one or more components. For example, an ad template can be a creative that specifies one or more component slots each requiring a component of a desired component type, such as a background image, a headline, a promotional slogan, a product image, a price quote, a landing page URL, a call-to-action (e.g., a message promoting a viewer action such as “Register Now!”), and so on. A component can be associated with a single component type based on the component's structural or format characteristics or the component's function in the ad template. In some implementations, a component may also be associated with various attribute values (e.g., color, font, model number, customer rating, etc.). As used in this specification, a component is a data item that has structural and format qualities meeting the specifications of a component type. Components of the same component type are interchangeable in a corresponding component slot of a content item template when constructing a content item. Content items generated using different components for the same component slots are identical except for the portions of each content item that are affected by the content and/or attributes of the different components.

Multiple (e.g., from a few, tens of thousands, to potentially tens of millions) components of each component type can be made available for selection and application to a component slot in the ad template. Components of the same component type can have varying content (e.g., text, image theme, price value, etc.), and descriptive labels of the varying content can be associated with each component. The descriptive labels allow a suitable component to be selected for a component slot based not only on component type but also on content. In some implementations, attribute values can also be used as criteria for selecting a component.

Components available for constructing a dynamic ad can be provided by one or more data feeds. An advertisement management system can select from the data feeds suitable components for the component slots in an ad template in response to a received ad request. The dynamic ad can be created when the selected components are applied to the component slots according to the specifications of the ad template. The created dynamic ad can then be delivered to a requesting user device for presentation.

The advertiser can modify or update the components available in the data feed or data store frequently and have the changes timely reflected in the dynamic ads generated and delivered in response to each ad request.

In addition to varying the quantity and content of the components available for selection in the data feeds, an advertiser can also design various business rules by which the components can be selected for a dynamic ad in response to a received ad request. Some of the business rules can be independently applied. For example, one business rule can specify that a “headline” component slot in an ad template can only be filled by a headline component that contains words matching a keyword specified in the ad request. Another business rule can specify that a product image slot in the ad template can only be filled by a product image having a warm color scheme for ad requests received during the winter months and a cool color scheme for ad requests received during the summer months. In the above example, the first business rule and the second business rule are independently applied, and the selection of components based on the first business rule does not have any influence on the selection of components based on the second business rule, absent any inter-slot constraints.

Multiple business rules can be specified by the advertiser for the construction of a dynamic ad. The business rules can be slot dependent, time dependent, demographic dependent, geographic dependent, and so on. Some business rules can also be conditionally applied. For example, a conditional business rule can specify that components showing promotional prices are only used in a dynamic ad if the click-through rates of past ads did not reach a predetermined threshold value.

The methods and systems described herein may be implemented using computer programming or engineering techniques including computer software, firmware, hardware or any combination or subset thereof, wherein the technical effect may be achieved by performing at least one of the following steps: a) retrieving from the memory device a stored template for an advertisement, wherein when displayed to an online user within a web page, at least one component of the advertisement is configurable in response to at least one characteristic associated with the online user; b) receiving first build data to generate a first variation of the advertisement, wherein the at least one component of the advertisement is configured in response to a first defined characteristic inputted by a reviewer; c) generating the first variation of the advertisement; d) receiving second build data to generate a second variation of the advertisement, wherein the at least one component of the advertisement is configured in response to a second defined characteristic inputted by the reviewer; e) generating the second variation of the advertisement; f) presenting to the user interface the first and second variations of the advertisement for selective display to the reviewer; g) storing the first and second build data associated with the generation of the first and second variations of the advertisement to enable subsequent regeneration of the first and second variations of the advertisement; h) receiving a selection from the reviewer of at least one item of build data associated with a characteristic of at least one of an online user and the advertiser; i) maintaining the at least one selected item of build data constant during generation of a plurality of variations of the advertisement; j) generating a display on the user interface, the display including a simultaneous presentation of at least the first and second variations of the advertisement; and k) assigning a security level to the stored first and second build data.

The following description refers to the accompanying drawings, in which, in the absence of a contrary representation, the same numbers in different drawings represent similar elements.

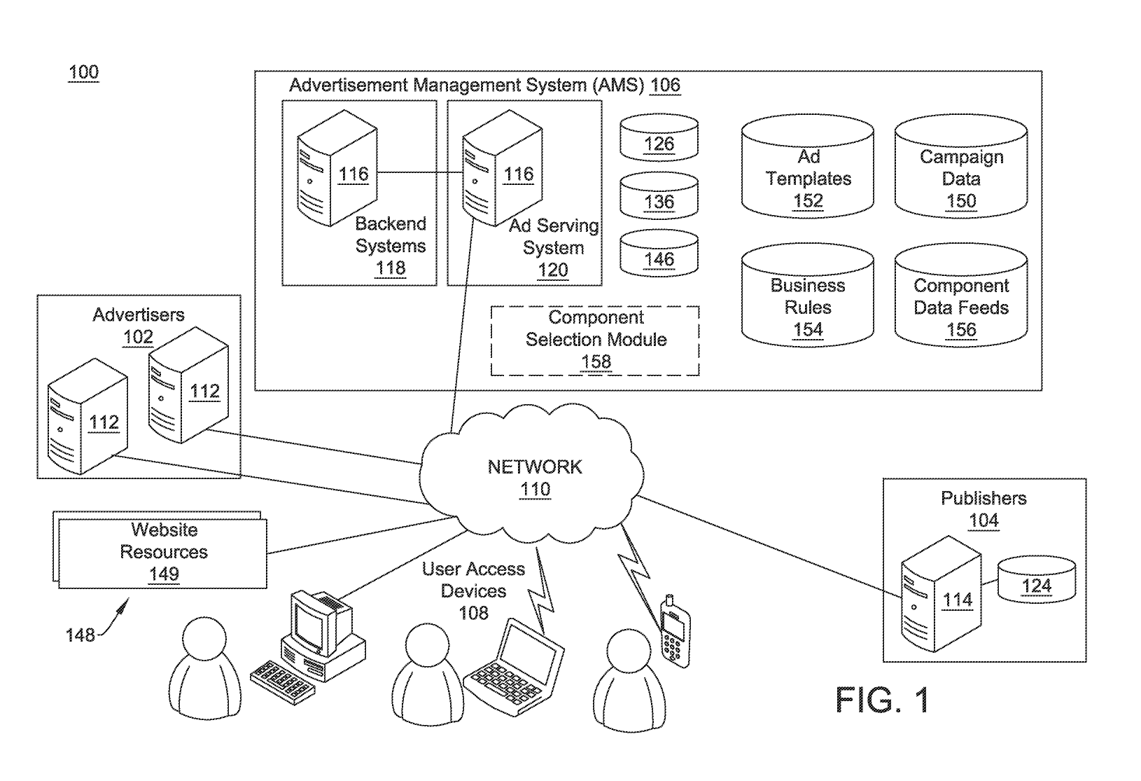

With reference to FIG. 1, an example advertising environment 100 may include one or more advertisers 102, one or more publishers 104, an advertisement management system (AMS) 106, and one or more user access devices 108, which may be coupled to a network 110. Each of the elements 102, 104, 106, 108 and 110 in FIG. 1 may be implemented or associated with hardware components, software components, or firmware components or any combination of such components. The elements 102, 104, 106, 108 and 110 can, for example, be implemented or associated with general purpose servers, software processes and engines, and/or various embedded systems. The elements 102, 104, 106 and 110 may serve, for example, as an advertisement distribution network. While reference is made to distributing advertisements, the environment 100 can be suitable for distributing other forms of content including other forms of sponsored content.

The advertisers 102 may include any entities that are associated with advertisements (“ads”). An advertisement or an “ad” refers to any form of communication in which one or more products, services, ideas, messages, people, organizations or other items are identified and promoted (or otherwise communicated). Ads are not limited to commercial promotions or other communications. An ad may be a public service announcement or any other type of notice, such as a public notice published in printed or electronic press or a broadcast. An ad may be referred to or include sponsored content.

Ads may be communicated via various mediums and in various forms. In some examples, ads may be communicated through an interactive medium, such as the Internet, and may include graphical ads (e.g., banner ads), textual ads, image ads, audio ads, video ads, ads combining one of more of any of such components, or any form of electronically delivered advertisement. Ads may include embedded information, such as embedded media, links, meta-information, and/or machine executable instructions. Ads could also be communicated through RSS (Really Simple Syndication) feeds, radio channels, television channels, print media, and other media.

The term “ad” can refer to both a single “creative” and an “ad group.” A creative refers to any entity that represents one ad impression. An ad impression refers to any form of presentation of an ad such that it is viewable/receivable by a user. In some examples, an ad impression may occur when an ad is displayed on a display device of a user access device. An ad group refers, for example, to an entity that represents a group of creatives that share a common characteristic, such as having the same ad selection and recommendation criteria. Ad groups can be used to create an ad campaign.

The advertisers 102 may provide (or be otherwise associated with) products and/or services related to ads. The advertisers 102 may include or be associated with, for example, retailers, wholesalers, warehouses, manufacturers, distributors, health care providers, educational establishments, financial establishments, technology providers, energy providers, utility providers, or any other product or service providers or distributors.

The advertisers 102 may directly or indirectly generate maintain, review and/or analyze ads, which may be related to products or services offered by or otherwise associated with the advertisers. The advertisers 102 may include or maintain one or more data processing systems 112, such as servers or embedded systems, coupled to the network 110. The advertisers 102 may include or maintain one or more processes that run on one or more data processing systems.

The publishers 104 may include any entities that generate, maintain, provide, present and/or otherwise process content in the environment 100. “Publishers,” in particular, includes authors of online content, wherein authors may be individual persons, or, in the case of works made for hire, the proprietor(s) who hired the individual(s) responsible for creating the online content. The term “content” refers to various types of web-based and/or otherwise presented information, such as articles, discussion threads, reports, analyses, financial statements, music, video, graphics, search results, web page listings, information feeds (e.g., RSS feeds), television broadcasts, radio broadcasts, printed publications, etc.

In some implementations, the publishers 104 may include content providers with an Internet presence, such as online publication and news providers (e.g., online newspapers, online magazines, television websites, etc.), online service providers (e.g., financial service providers, health service providers, etc.), and the like. The publishers 104 can include television broadcasters, radio broadcasters, satellite broadcasters, and other content providers. One or more of the publishers 104 may represent a content network that is associated with the AMS 106.

The publishers 104 may receive requests from the user access devices 108 (or other elements in the environment 100) and provide or present content to the requesting devices. The publishers may provide or present content via various mediums and in various forms, including web based and non-web based mediums and forms. The publishers 104 may generate and/or maintain such content and/or retrieve the content from other network resources.

In addition to content, the publishers 104 may be configured to integrate or combine retrieved content with ads that are related or relevant to the retrieved content for display to users. As discussed further below, these relevant ads may be provided from the AMS 106 and be combined with content for display to users. In some examples, the publishers 104 may retrieve content for display on a particular user access device 108 and then forward the content to the user access device 108 along with code that causes one or more ads from the AMS 106 to be displayed to the user. In other examples, the publishers 104 may retrieve content, retrieve one or more relevant ads (e.g., from the AMS 106 or the advertisers 102), and then integrate the ads and the article to form a content page for display to the user.

As noted above, one or more of the publishers 104 may represent a content network. In such an implementation, the advertisers 102 may be able to present ads to users through this content network.

The publishers 104 may include or maintain one or more data processing systems 114, such as servers or embedded systems, coupled to the network 110. They may include or maintain one or more processes that run on data processing systems. In some examples, the publishers 104 may include one or more content repositories 124 for storing content and other information.

The AMS 106 manages ads and provides various services to the advertisers 102, the publishers 104, and the user access devices 108. The AMS 106 may store ads in an ad repository 136 and facilitate the distribution or selective provision and recommendation of ads through the environment 100 to the user access devices 108. In some configurations, the AMS 106 may include or access functionality associated with other advertisement systems.

The AMS 106 may include one or more data processing systems 116, such as servers or embedded systems, coupled to the network 110. It can also include one or more processes, such as server processes. In some examples, the AMS 106 may include an ad serving system 120 and one or more backend processing systems 118. The ad serving system 120 may include one or more data processing systems 116 and may perform functionality associated with delivering ads to publishers or user access devices. The backend processing systems 118 may include one or more data processing systems 116 may perform functionality associated with identifying relevant ads to deliver, processing various rules, performing filtering processes, generating reports, maintaining accounts and usage information, and other backend system processing. The AMS 106 can use the backend processing systems 118 and the ad serving system 120 to selectively recommend and provide relevant ads from the advertisers 102 through the publishers 104 to the user access devices 108.

The AMS 106 may include or access one or more crawling, indexing and searching modules (not shown). These modules may browse accessible resources (e.g., the World Wide Web, publisher content, data feeds, etc.) to identify, index and store information. The modules may browse information and create copies of the browsed information for subsequent processing. The modules may also check links, validate code, harvest information, and/or perform other maintenance or other tasks.

Searching modules may search information from various resources, such as the World Wide Web, publisher content, intranets, newsgroups, databases, and/or directories. The search modules may employ one or more known search or other processes to search data. In some implementations, the search modules may index crawled content and/or content received from data feeds to build one or more search indices. The search indices may be used to facilitate rapid retrieval of information relevant to a search query.

The AMS 106 may include one or more interface or frontend modules for providing the various features to advertisers, publishers, and user access devices. For example, the AMS 106 may provide one or more publisher front-end interfaces (PFEs) for allowing publishers to interact with the AMS 106. The AMS 106 may also provide one or more advertiser front-end interfaces (AFEs) for allowing advertisers to interact with the AMS 106. In some examples, the front-end interfaces may be configured as web applications that provide users with network access to features available in the AMS 106.

The AMS 106 provides various advertising management features to the advertisers 102. The AMS 106 advertising features may allow users to set up user accounts, set account preferences, create ads, select keywords for ads, create campaigns or initiatives for multiple products or businesses, view reports associated with accounts, analyze costs and return on investment, selectively identify customers in different regions, selectively recommend and provide ads to particular publishers, analyze financial information, analyze ad performance, estimate ad traffic, access keyword tools, add graphics and animations to ads, etc.

The AMS 106 may allow the advertisers 102 to create ads and input keywords for which those ads will appear. In some examples, the AMS 106 may provide ads to user access devices or publishers when keywords associated with those ads are included in a user request or requested content. The AMS 106 may also allow the advertisers 102 to set bids for ads. A bid may represent the maximum amount an advertiser is willing to pay for each ad impression, user click-through of an ad or other interaction with an ad. A click-through can include any action a user takes to select an ad. The advertisers 102 may also choose a currency and monthly budget.

The AMS 106 may also allow the advertisers 102 to view information about ad impressions, which may be maintained by the AMS 106. The AMS 106 may be configured to determine and maintain the number of ad impressions relative to a particular website or keyword. The AMS 106 may also determine and maintain the number of click-throughs for an ad as well as the ratio of click-throughs to impressions.

The AMS 106 may also allow the advertisers 102 to select and/or create conversion types for ads. A “conversion” may occur when a user consummates a transaction related to a given ad. A conversion could be defined to occur when a user clicks on an ad, is referred to the advertiser's web page, and consummates a purchase there before leaving that web page. In another example, a conversion could be defined as the display of an ad to a user and a corresponding purchase on the advertiser's web page within a predetermined time (e.g., seven days). The AMS 106 may store conversion data and other information in a conversion data repository 136.

The AMS 106 may allow the advertisers 102 to input description information associated with ads. This information could be used to assist the publishers 104 in determining ads to publish. The advertisers 102 may additionally input a cost/value associated with selected conversion types, such as a five dollar credit to the publishers 104 for each product or service purchased.

The AMS 106 may provide various features to the publishers 104. The AMS 106 may deliver ads (associated with the advertisers 102) to the user access devices 108 when users access content from the publishers 104. The AMS 106 can be configured to deliver ads that are relevant to publisher sites, site content and publisher audiences.

In some examples, the AMS 106 may crawl content provided by the publishers 104 and deliver ads that are relevant to publisher sites, site content and publisher audiences based on the crawled content. The AMS 106 may also selectively recommend and/or provide ads based on user information and behavior, such as particular search queries performed on a search engine website, etc. The AMS 106 may store user-related information in a general database 146. In some examples, the AMS 106 can add search services (e.g., a search box) to a publisher site and deliver ads configured to provide appropriate and relevant content relative to search results generated by requests from visitors of the publisher site. A combination of these and other approaches can be used to deliver relevant ads.

The AMS 106 may allow the publishers 104 to search and select specific products and services as well as associated ads to be displayed with content provided by the publishers 104. For example, the publishers 104 may search through ads in the ad repository 136 and select certain ads for display with their content.

The AMS 106 may be configured to selectively recommend and provide ads created by the advertisers 102 to the user access devices 108 directly or through the publishers 104. The AMS 106 may selectively recommend and provide ads to a particular publisher 104 (as described in further detail herein) or a requesting user access device 108 when a user requests search results or loads content from the publisher 104.

In some implementations, the AMS 106 may manage and process financial transactions among and between elements in the environment 100. For example, the AMS 106 may credit accounts associated with the publishers 104 and debit accounts of the advertisers 102. These and other transactions may be based on conversion data, impressions information and/or click-through rates received and maintained by the AMS 106.

The user access devices 108 may include any devices capable of receiving information from the network 110. The user access devices 108 could include general computing components and/or embedded systems optimized with specific components for performing specific tasks. Examples of user access devices include personal computers (e.g., desktop computers), mobile computing devices, cell phones, smart phones, media players/recorders, music players, game consoles, media centers, media players, electronic tablets, personal digital assistants (PDAs), television systems, audio systems, radio systems, removable storage devices, navigation systems, set top boxes, other electronic devices and the like. The user access devices 108 can also include various other elements, such as processes running on various machines.

The network 110 may include any element or system that facilitates communications among and between various network nodes, such as elements 108, 112, 114 and 116. The network 110 may include one or more telecommunications networks, such as computer networks, telephone or other communications networks, the Internet, etc. The network 110 may include a shared, public, or private data network encompassing a wide area (e.g., WAN) or local area (e.g., LAN). In some implementations, the network 110 may facilitate data exchange by way of packet switching using the Internet Protocol (IP). The network 110 may facilitate wired and/or wireless connectivity and communication.

Environment 100 further includes a website 148 including one or more resources 149 (e.g., text, images, multimedia content, and programming elements, such as scripts) associated with a domain name and hosted by one or more servers. Resources 149 can be relatively static (e.g., as in a publisher's webpage) or dynamically generated in response to user query (e.g., as in a search engine's result page).

User devices 108 can request resources 149 from a website 148. In turn, build data representing the resource 149 can be provided to the user access device 108 for presentation by the user access device 108. The build data representing the resource 149 can also include data specifying an ad slot in which advertisements can be presented.

When a resource 149 is requested by a user access device 108, the advertisement management system 106 receives a request for advertisements to be provided with the resource 149. The request for advertisements can include characteristics of the advertisement slots (e.g., size, web address of the resource, media type of the requested advertisement, etc.) that are defined for the requested resource or search results page, and can be provided to the advertising management system 106.

Based on data included in the request for advertisements, the advertising management system 106 can identify advertisements that are eligible to be provided in response to the request. For example, eligible advertisements can have characteristics matching the characteristics of available advertisement slots and have ad serving keywords that match the specified resource keywords or search queries.

Each advertiser 102 can create one or more advertising campaigns using various campaign parameters that are used to control distribution of the advertiser's advertisements. Each advertising campaign can include one or more ad groups that have modified campaign parameters that are specific to the ad group. Examples of campaign parameters can include ad serving keywords and corresponding bids, geographic or other factors used to facilitate ad serving, delivery period, content network, keyword match type, as well as other parameters corresponding to one or more advertisements. The campaign data can be stored in the campaign data store 150. The advertising management system 106 can retrieve the information in the campaign data store 150 when preparing a response to an ad request.

Parameters related to an advertisement can include, for example, creative identifier, creative name, creative type, size, first line, web address of the landing page, display URL, media type, and so on. One of the creative types that an advertiser can specify for an ad is the dynamic ad type. The advertiser can provide an ad template as the creative, and the ad template can be selected (e.g., in the same manner as other types of creatives) to fulfill a received ad request for an available advertisement slot. When an ad template (or in other words, a dynamic ad creative) is selected to fulfill an ad request, a dynamic ad can be generated on-the-fly based on the ad template to fulfill the ad request.

The ad template can specify the general appearance, such as an invariable portion of the content and some aspects of the appearance and format of the dynamic ad. The invariable portion of the content and aspects of the dynamic ad remains the same across multiple dynamic ads generated using the same ad template.

In addition to specifying the invariable portion of the dynamic ad, the ad template also leaves some content or aspects of format and appearance of the dynamic ad unspecified. Instead, the ad template can specify one or more component slots which prescribe the requirements for data items (or components) that can be used to provide the unspecified content and aspects of format and appearance to complete the dynamic ad. Components having component characteristics (e.g., content, structural format, function, or other attributes) that satisfy the requirements of the component slots can be selected and inserted into the component slots to complete the dynamic ad. In some implementations, the ad templates can also specify how a selected component is applied to the component slot, such as the size, font, color, position, etc. of the selected component as the component appears in the dynamic ad.

The advertisers can specify multiple dynamic ad creatives or ad templates for use in the advertiser's ad campaigns. The ad templates can be stored along with other creatives (e.g., static image ads, video ads, text ads, etc.) in the campaign data store 150. In some implementations, the ad templates can be stored separately from the other types of creatives, for example, in an ad template data store 152. Individual ad templates can be retrieved by the advertising management system 106 by the templates' creative IDs.

The advertising management system 106 can have access to a large number of available components of various types, for example, through a component data feed store 156. The components can have varying content. The component data feed store 156 can be provided and updated by the advertiser from time to time. In some implementations, the component data feed store 156 can be linked to the advertiser's product catalogs or other business data stores, such that real-time data can be made available to the advertising management system 106 without active intervention by the advertiser.

The advertising management system 106 can select components from among the large number of components available in the component data feed store 156. The advertising management system 106 can also apply the selected components to the component slots in a dynamic ad according to the specifications in an ad template selected from the ad template data store 152. Once the dynamic ad is constructed using the selected components, the dynamic ad can be provided by an advertisement management system to fulfill the received ad request. In some implementations, a component selection module 158 can be implemented to carry out actions related to component selection. The component selection module 158 can be part of the advertising management system 106 or a standalone module in communication with the advertising management system 106.

When the advertisement management system 106 selects components for the selected ad template in response to a received ad request, the advertisement management system 106 observes the business rules including the co-occurrence constraints specified for the selected ad template. The business rules can be specified by the advertiser through an interface provided by the advertisement management system 106. The business rules can be stored in the campaign data store along with other campaign data. Alternatively, the business rules can be stored in a business rule data store 154 apart from other types of campaign data. The business rules can be campaign specific, ad group specific, or ad template specific, for example.

For purposes of explanation only, certain aspects of this disclosure are described with reference to the discrete elements illustrated in FIG. 1. The number, identity and arrangement of elements in the environment 100 are not limited to what is shown. For example, the environment 100 can include any number of geographically-dispersed advertisers 102, publishers 104 and/or user access devices 108, which may be discrete, integrated modules or distributed systems. Similarly, the environment 100 is not limited to a single AMS 106 and may include any number of integrated or distributed AMS systems or elements.

Furthermore, additional and/or different elements not shown may be contained in or coupled to the elements shown in FIG. 1, and/or certain illustrated elements may be absent. In some examples, the functions provided by the illustrated elements could be performed by less than the illustrated number of components or even by a single element. The illustrated elements could be implemented as individual processes run on separate machines or a single process running on a single machine.

An advertiser can specify parameters of advertising campaigns and advertisements through an advertising management system. The advertising management system can receive ad requests from user devices and select ads according to information in the ad requests and the parameters of the advertising campaigns. The ads that are delivered can include dynamically generated ads as described above.

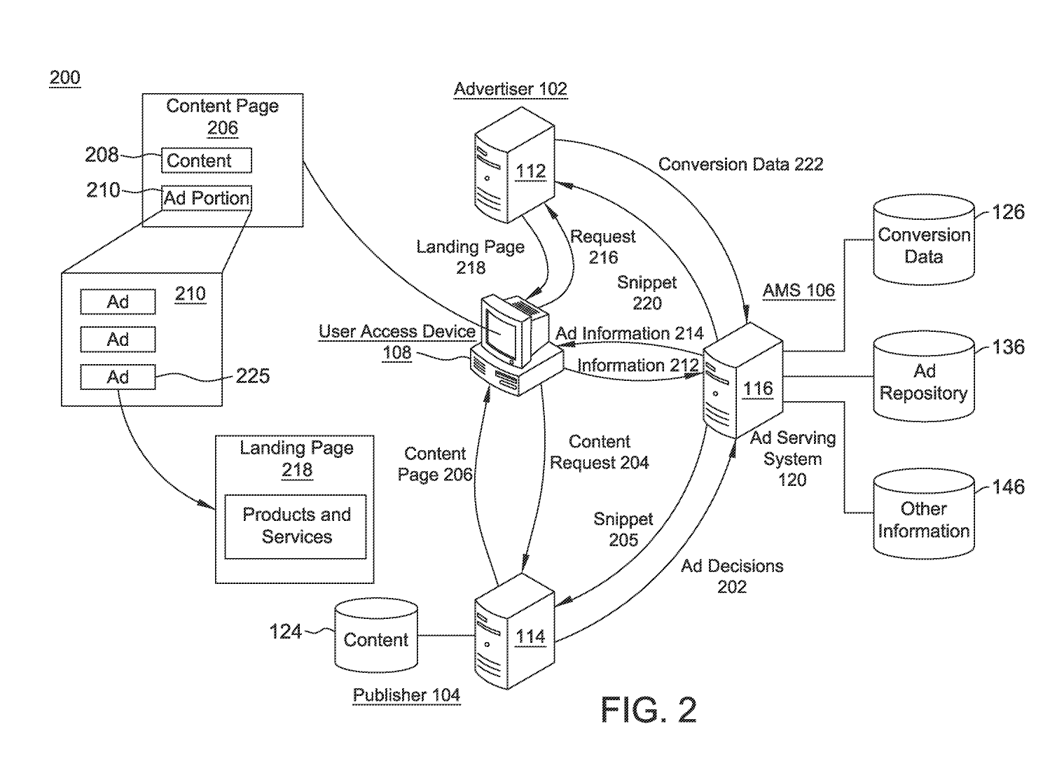

FIG. 2 illustrates an example data flow 200 within the environment 100. The data flow 200 is an example only and not intended to be restrictive. Other data flows may therefore occur in the environment 100 and, even with the data flow 200, the illustrated events and their particular order in time may vary.

In the data flow 200, the AMS 106 stores ads from the advertisers 102 and receives ad decisions 202 from a particular publisher 104. The ad decisions 202 can include decisions to approve and/or disapprove certain ads and/or advertisers. These ad decisions can be based on aggregated ratings or scores, associated with ads/advertisers that are provided to the publisher 104 by the AMS 106. Such aggregated scores can represent ratings of ads/advertisers received from multiple publishers 104.

During the data flow 200, the publisher 104 may receive a content request 204 from a particular user access device 108. The content request 204 may, for example, include a request for a web document on a given topic (e.g., automobiles). In response to the content request 204, the publisher 104 may retrieve relevant content (e.g., an automobile article) from the content repository 124 or some other source.

The publisher 104 may respond to the content request 204 by sending a content page 206 or other presentation to the requesting user access device 108. The content page 206 may include the requested content 208 (e.g., the automobile article) as well as a code “snippet” 205 associated with an ad. A code “snippet” refers, for example, to a method used by one device (e.g., a server) to ask another device (e.g., a browser running on a client device) to perform actions after or while downloading information. In some examples, a code “snippet” may be implemented in JAVASCRIPT® code or may be part of HTML (Hypertext Markup Language) or other web page markup language or content.

The AMS 106 may provide the code snippet 205 to the publisher 104 and/or the user access device 108. The code snippet can originate and/or be provided from other sources. As the requesting user access device 108 loads the content page 206, the code snippet 205 causes the user access device 108 to contact the AMS 106 and receive additional code (e.g., JAVASCRIPT® or the like), which causes the content page 206 to load with an ad portion 210.

The ad portion 210 may include any element that allows information to be embedded within the content page 206. In some examples, the ad portion 210 may be implemented as an HTML element, such an I-Frame (inline frame) or other type of frame. The ad portion 210 may be hosted by the AMS 106 or the publisher 104 and may allow content (e.g., ads) from the AMS 106 or the publisher 104 to be embedded inside the content page 206. Parameters associated with the ad portion 210 (e.g., its size and shape) can be specified in the content page 206 (e.g., in HTML), so that the user access device 108 can present the content page 206 while the ad portion 210 is being loaded. Other implementations of ad portion 210 may also be used.

The ad portion 210 may send the AMS 106 formatting and content information 212. This information 212 may include information describing the manner (e.g., how, when, and/or where) in which ads can be rendered by the user access devices 108. The information 212 may also include ad attributes and parameters, such as size, shape, color, font, presentation style (e.g., audio, video, graphical, textual, etc.), etc. The information 212 may also specify a quantity of ads desired.

The formatting and content information 212 can include information associated with the requested content 208 displayed in content page 206. Such information may include a URL associated with the requested content page 206. The information 212 can include the requested content itself, a category corresponding to the requested content or the content request, part or all of the content request 204, content age, content type (e.g., text, graphics, video, audio, mixed media, etc.), geo-location information, and the like.

In response to the information 212, the AMS 106 may provide the user access device 108 with ad information 214. The ad information 214 may include one or more ads 225 for placement in the ad portion 210 of the content page 206. The ad information 214 may also include a signed or encoded specification of an ad.

The ad information 214 may include ads that are relevant to user interest. The AMS 106 may retrieve and provide relevant ads based on the information 212 received from the user access device 108. The AMS 106 may retrieve the ad information 214 from the ad repository 136 using the backend processing systems 118. The AMS 106 may retrieve relevant ads using information from a crawling module, various keywords, various statistical associations between ads and content, and/or preference information associated with the publishers.

The AMS 106 may decide whether to serve certain ads with publisher content based on the ad decision 202 received from the publisher 104. For example, the AMS 106 may identify a relevant ad from the ad repository 136 based on keywords but may decide that the ad should not be served with the publisher content (e.g., the requested automobile document) because the publisher 104 has indicated in the ad decisions 202 a disapproval of the identified ad. In some examples, these ad serving decisions may be based on rules maintained by the backend processing systems 118.

The ad portion 210 may populate with ads included in the ad information 214, such as ads 225. The ad portion 210 and the displayed ads 225 may occupy a portion of the content page 206, which may be distinct from other content (e.g., the requested content 208) in the content page 206.

When a user clicks on the displayed ad 225, an embedded code snippet may direct the user access device 108 to contact the AMS 106. During this event, the user access device 108 may receive an information parcel, such as a signed browser cookie, from the AMS 106. This information parcel can include information, such as an identifier of the selected ad 225, an identifier of the publisher 104, and the date/time the ad 225 was selected by the user. The information parcel may facilitate processing of conversion activities or other user transactions.

The user access device 108 may then be redirected to the advertiser 102 associated with the selected ad 225. The user access device 108 may send a request 216 to the associated advertiser 102 and then load a landing page 218 from the advertiser 102. The user may then perform a conversion action at the landing page 218, such as purchasing a product or service, registering, joining a mailing list, etc. A code snippet 220, which may be provided by the AMS 106, may be included within a conversion confirmation page script, such as a script within a web page presented after the purchase. The user access device 108 may execute the code snippet 220, which may then contact the AMS 106 and report conversion data 222 to the AMS 106. The conversion data 222 may include conversion types and numbers as well as information from cookies. The conversion data 222 may be maintained in the conversion data repository 136.

FIG. 2 is an example only and not intended to be restrictive. Other data flows may therefore occur in the environment 100 and, even with the data flow 200, the illustrated events and their particular order in time may vary. Further, the illustrated events may overlap and/or may exist in fewer steps. Moreover, certain events may not be present and additional and/or different events may be included.

In alternative data flows, the AMS 106 can allow advertisers to approve publishers in a manner similar to the manner in which publishers approve advertisers. In such data flows, the AMS 106 can receive publisher decisions (i.e., decisions about publishers) from one or more advertisers 102. The publisher decisions made by advertisers can include approvals and disapprovals of certain publishers. These approval/disapproval decisions can be based on aggregated scores, associated with publishers that are provided to advertisers. The aggregated scores can represent ratings of publishers received from multiple advertisers 102. When providing relevant ads to the user access devices 108, the AMS 106 may take into account these publisher approvals/disapprovals. For example, the AMS 106 may decide to not provide an otherwise relevant ad to a given publisher based on the advertiser's disapproval of that publisher. Not providing a relevant ad to a publisher can include not bidding in an auction for publisher ad space.

In alternative data flows, the publisher 104 can send an ad request to the AMS 106 prior to sending a content page to the user access device 108. The AMS 106 may respond by sending relevant ads to the publisher 104. The publisher 104 may combine the received ads with requested content in the content page and then send the content page, including the ad portion, to the user access device 108 for display to a user.

In alternative data flows, the AMS 106 may selectively recommend and provide ads to the user access devices 108 based on search terms provided by the user access devices 108. In these dataflows, the AMS 106 may provide searching services and receive search terms directly from the user access devices. The AMS 106 can also receive search terms from a dedicated searching system that receives user search requests. The AMS 106 may selectively recommend and provide ads to the user access devices based on the received search terms and ad keywords provided by the advertisers. Other modifications to the data flow 200 are also possible.

In situations in which the systems discussed herein collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

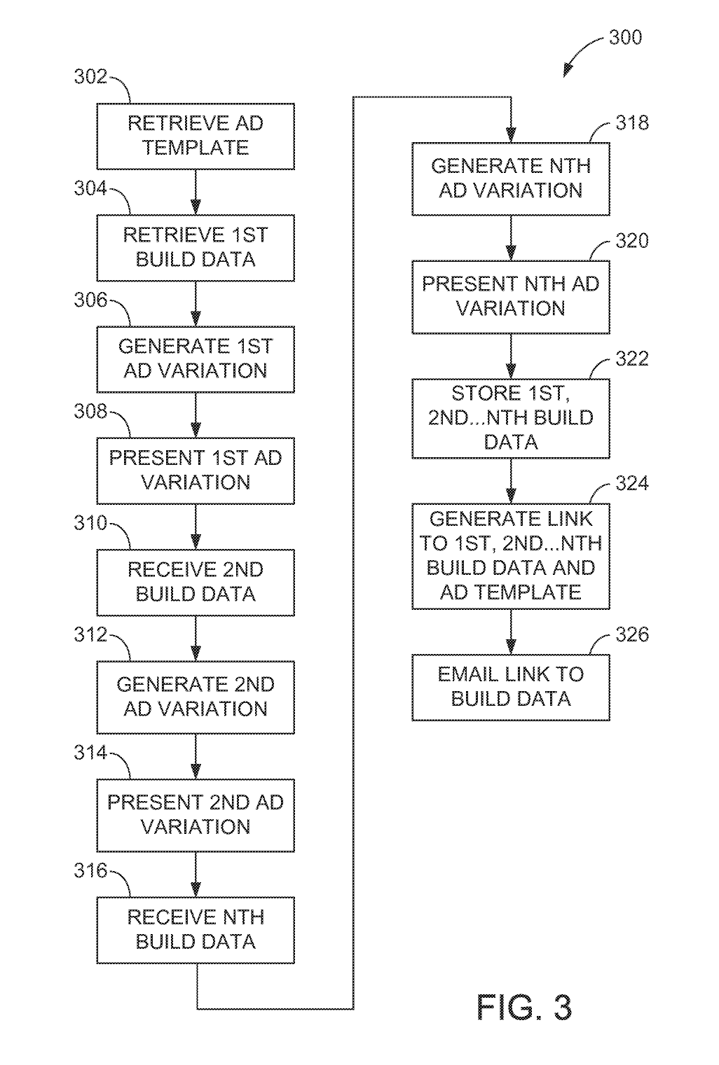

FIG. 3 is a flowchart of an example method 300 employed by AMS 106 for enabling preview, approval and testing of advertisements (also referred to as “tearsheets”). In an example embodiment, AMS 106 retrieves 302 an advertisement template from a plurality of templates for dynamically-created advertisements stored, in the example embodiment, in ad repository 136 of AMS 106. A reviewer logs into AMS 106 and accesses a user interface configured to permit the reviewer to input data necessary to simulate the situation of an online user having specific characteristics, such as country of location, gender, age, product or subject matter being searched, etc. Upon receipt 304 of the first (1^{st}) set of build data, AMS 106 generates 306 a first (1^{st}) variation of the advertisement. AMS 106 then presents 308 the first variation of the advertisement to the user interface for review by the reviewer. After generation 306 and presentation 308 of the first variation of an advertisement, AMS 106 receives 310 a second (2^{nd}) build data set to generate 312 and subsequently present 314 a second variation of the advertisement, upon entry by a reviewer of the desired data. Method 300 continues with the receipt of build data, generation of a variation of the advertisement, and presentation of the generated variation of the advertisement to the reviewer, until the n^{th} set of build data is received 316, and the n^{th} variation of the advertisement is generated 318, and presented 320 to the reviewer. AMS 106 stores 324 the 1^{st}, 2^{nd} . . . n^{th} sets of build data, for example, in ad repository 136. AMS 106 then generates 324 a web link to the stored sets of build data, as well as to the relevant ad template. At the reviewer's instruction, AMS 106 then emails 326 the link to recipients identified by the reviewer.

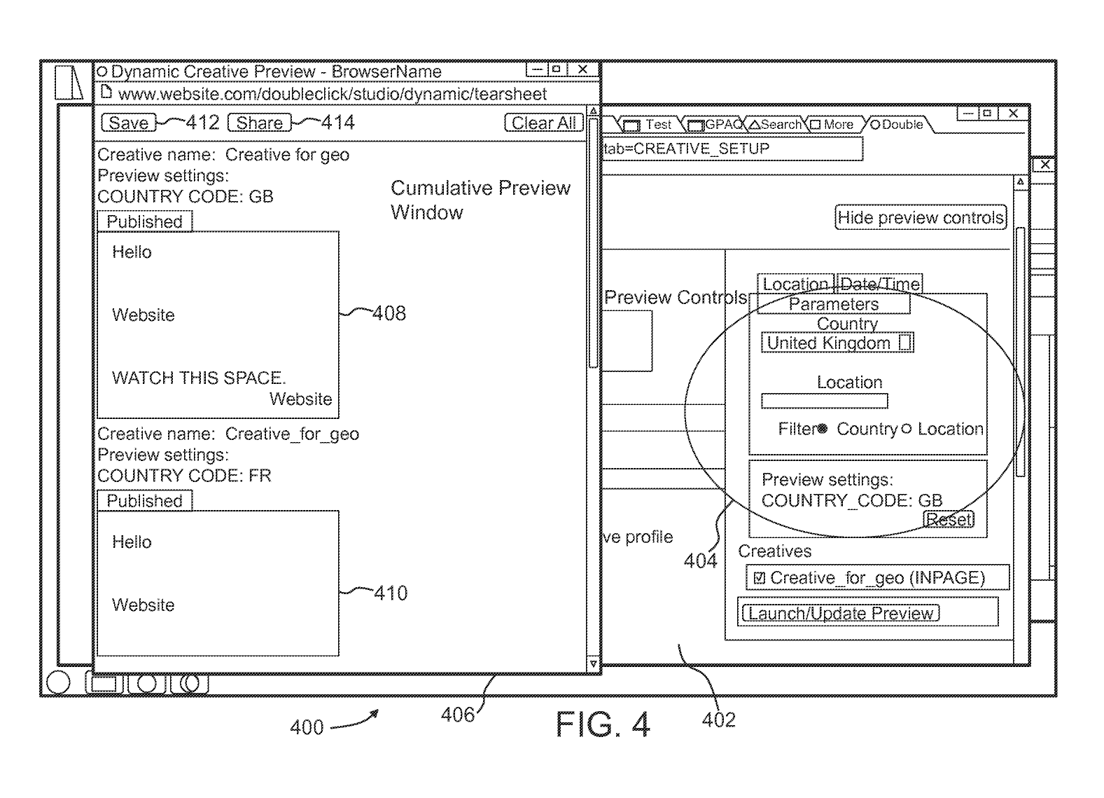

FIG. 4 illustrates an example screenshot 400 of a user interface used by a reviewer to generate variations of an advertisement. The user interface includes a display 402, which includes a data input field 404, in which data, such as country identification, is entered. Additional input fields (not shown) are provided to enter identifiers for the particular advertisement of interest. As each variation of an advertisement is generated, the variations are captured in a cumulative preview window 406. Alternatively, AMS 106 generates images for all generated advertisements and presents the advertisements on display 402 after actuation of a “display” instruction by the reviewer. In the example embodiment, variations for Great Britain (GB) 408 and France (FR) 410 are illustrated in cumulative preview window 406. In an example embodiment, AMS 106 is configured to automatically adjust the size of the advertisements to accommodate additional images, though as a practical matter of viewability, AMS 106 may be configured to impose a maximum of about 15-20 images. In the event that a greater number of advertisements are generated, the captured images are overlapped or stacked.

Returning to FIG. 3, as described, after all desired variations of an advertisement are generated and captured, a reviewer has the option to store, or “save” 322 the generated advertisements. As shown in FIG. 4, the user interface provides in cumulative preview window 406 a “save” button 412. In executing a “save” 322, AMS 106 stores in an appropriately designated file, the underlying build data used to generate the 1^{st} through n^{th} advertisement variations, rather than the images of the 1^{st} through n^{th} advertisements. Accordingly, when a reviewer transmits the saved advertisements to a third party for review the files are configured to function as links into AMS 106. When a third party opens a file of saved advertisements, AMS 106 regenerates each advertisement in real-time using the previously-saved build data. Accordingly, AMS 106 is able to implement any changes that may have been made to the underlying templates for the advertisements. While this may result in a set of advertisement previews (or tearsheets) that appear differently than those originally reviewed, the resulting tearsheets will have the advantage of being current.

In an example embodiment, the user interface maintained by AMS 106 additionally provides a “share” button 414 in cumulative preview window 406. Upon “clicking” on share button 414 (step 324 in FIG. 3), AMS 106 generates an email window, with cumulative preview window 406 presented as an attachment to the email, or within the body of the email, etc. AMS 106 is configured to present saved advertisements to the user interface, for example, in the form of a table. In an example embodiment, AMS 106 is configured to save previewed advertisements for both published and unpublished advertisements. In this example embodiment, the table may be provided with function buttons such as launch (for unpublished advertisements) and update (for published advertisements).

In example embodiments, AMS 106 is further configured to provide additional functions for generation of advertisements for review. For example, in one embodiment, AMS 106 is configured to allow a reviewer to select or “pin” one or more characteristics of the advertisement. For example, a reviewer selects one of the variables (such as a specific product), and AMS 106 generates all valid permutations of the advertisement associated with that specific characteristic. In an alternative embodiment, AMS 106 is configured to permit a reviewer to pin multiple characteristics, to limit the number of advertisement variations generated.

In an example embodiment, AMS 106 is configured to permit reviewers to save tearsheets, load saved tearsheets for review, and delete existing tearsheets (whether saved or not) when no longer required. In an example embodiment, AMS 106 assigns a security level when a tearsheet is saved pursuant to an instruction from a user. For example, AMS 106 presents a reviewer the option to designate a saved tearsheet as viewable by all parties (such as when transmitting a tearsheet link via email—step 326 shown in FIG. 3), or as viewable only by registered users.

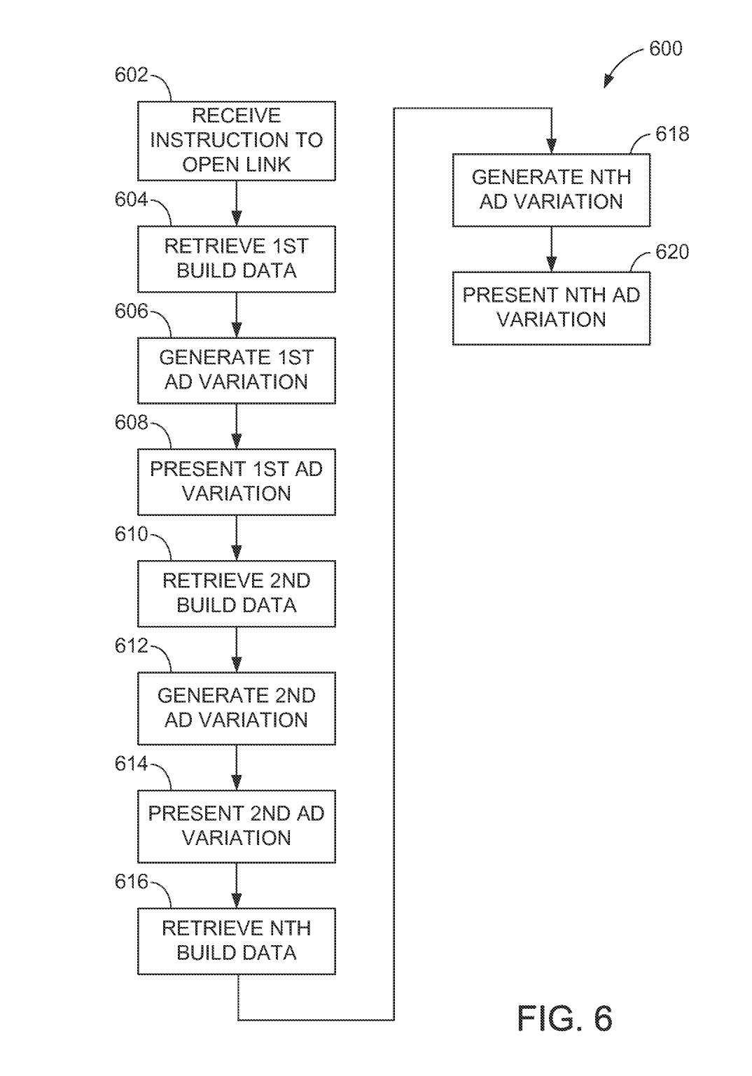

FIG. 6 is a flowchart of an example method for re-creation of advertisement variations by a recipient of a link to an advertisement review. A recipient receives an email from the reviewer containing the link. The recipient clicks on the link and AMS 106 receives 602 an instruction to open the link. AMS 106 retrieves 604 the stored (or saved) first 1^{st} set of build data, generates 606 the 1^{st} advertisement variation, and presents 608 the 1^{st} advertisement variation to the email recipient. AMS 106 then retrieves 610 the 2^{nd} set of build data, generates 612 the 2^{nd} advertisement variation, and presents 614 the 2^{nd} advertisement variation to the email recipient. AMS 106 proceeds with the retrieval of build data, and the generation and presentation of the subsequent variations of the advertisement, through to the retrieval 616 of the n^{th} set of build data, and the generation 618 and presentation 620 of the n^{th} variation of the advertisement to the email recipient. While the presentation 608, 614, 620 of the 1^{st}, 2^{nd} . . . nth versions of the advertisement is not literally simultaneous, because the versions of the advertisements are being successively generated by AMS 106 at a high rate of speed, their presentation may appear nearly simultaneous to the human recipient.

The foregoing detailed description illustrates embodiments of the invention by way of example and not by way of limitation. It is contemplated that the invention has general application to the review and revision of advertisements. It is further contemplated that the methods and systems described herein may be incorporated into existing online advertising planning systems, in addition to being maintained as a separate stand-alone application.

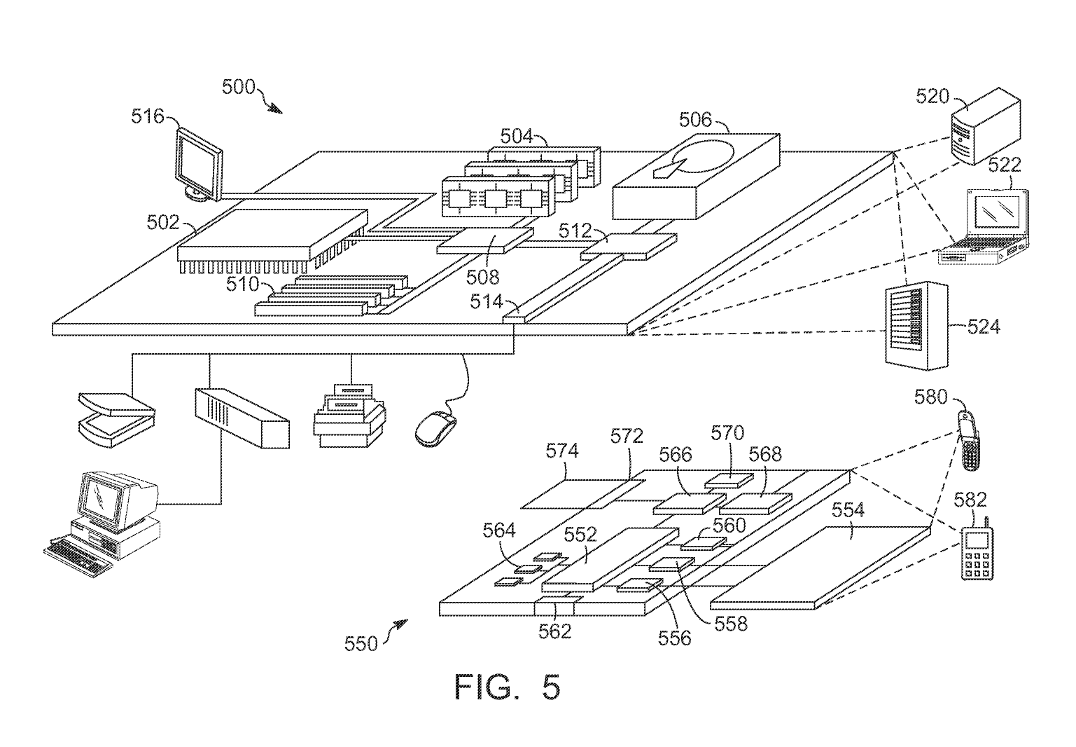

FIG. 5 is a diagram of example computing devices 500 and 550 that may be used in the environment shown in FIG. 1. More specifically, FIG. 5 shows an example of a generic computing device 500 and a generic mobile computing device 550, which may be used with the techniques described here. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smart phones, and other similar computing devices. The components shown here, their connections and relationships, and their functions, are meant to be examples only, and are not meant to limit implementations of the inventions described and/or claimed in this document.

Computing device 500 includes a processor 502, a memory 504, a storage device 506, a high-speed interface/controller 508 connecting to memory 504 and high-speed expansion ports 510, and a low speed interface/controller 512 connecting to a low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, or memory on processor 502.

The high speed controller 508 manages bandwidth-intensive operations for the computing device 500, while the low speed controller 512 manages lower bandwidth-intensive operations. Such allocation of functions is example only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed buss 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as computing device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The computing device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. The processor may provide, for example, for coordination of the other components of the computing device 550, such as control of user interfaces, applications run by computing device 550, and wireless communication by computing device 550.

Processor 552 may communicate with a user through control interface 558 and display interface 556 coupled to a display 554. The display 554 may be, for example, a TFT LCD (Thin-Film-Transistor Liquid Crystal Display) or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of computing device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to computing device 550 through expansion interface 572, which may include, for example, a SIMM (Single In Line Memory Module) card interface. Such expansion memory 574 may provide extra storage space for computing device 550, or may also store applications or other information for computing device 550. Specifically, expansion memory 574 may include instructions to carry out or supplement the processes described above, and may include secure information also. Thus, for example, expansion memory 574 may be provide as a security module for computing device 550, and may be programmed with instructions that permit secure use of computing device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552 that may be received, for example, over transceiver 568 or external interface 562.

Computing device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, Wi-Fi, or other such transceiver (not shown). In addition, GPS (Global Positioning system) receiver module 570 may provide additional navigation- and location-related wireless data to computing device 550, which may be used as appropriate by applications running on computing device 550.

Computing device 550 may also communicate audibly using audio codec 560, which may receive spoken information from a user and convert it to usable digital information. Audio codec 560 may likewise generate audible sound for a user, such as through a speaker, e.g., in a handset of computing device 550. Such sound may include sound from voice telephone calls, may include recorded sound (e.g., voice messages, music files, etc.) and may also include sound generated by applications operating on computing device 550.

The computing device 550 may be implemented in a number of different forms, as shown in the figure. For example, it may be implemented as a cellular telephone 580. It may also be implemented as part of a smart phone 582, personal digital assistant, a computer tablet, or other similar mobile device.

Thus, various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In the example embodiment, computing systems 500 and 552 are configured to receive and/or retrieve data pertaining to the creation, review and revision of online advertisements; data regarding advertisers, advertising links or impressions corresponding to those advertisers that appear on a web page, and metrics corresponding to the appearance of those impressions on that web page, etc., from various other computing devices connected to computing devices 500 and 552 through a communication network, and store this data within at least one of memory 504, storage device 506, and memory 564. Computing systems 500 and 552 are further configured to manage and organize the data within at least one of memory 504, storage device 506, and memory 564 using the techniques described herein.

The logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It will be appreciated that the above embodiments that have been described in particular detail are merely example or possible embodiments, and that there are many other combinations, additions, or alternatives that may be included.

Also, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely one example, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations may be used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or “providing” or the like, refer to the action and processes of a computer system, or similar electronic computing device, that manipulates and transforms data represented as physical (electronic) quantities within the computer system memories or registers or other such information storage, transmission or display devices.

Based on the foregoing specification, the above-discussed embodiments of the invention may be implemented using computer programming or engineering techniques including computer software, firmware, hardware or any combination or subset thereof. Any such resulting program, having computer-readable and/or computer-executable instructions, may be embodied or provided within one or more computer-readable media, thereby making a computer program product, i.e., an article of manufacture, according to the discussed embodiments of the invention. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

While the disclosure has been described in terms of various specific embodiments, it will be recognized that the disclosure can be practiced with modification within the spirit and scope of the claims.

What is claimed is:

1. A computer-implemented method for previewing and approving an advertisement, the method implemented using a computer device coupled to a user interface and a memory device, the method comprising:
retrieving from the memory device a stored template for an advertisement, wherein when displayed to an online user, at least one component of the advertisement is configurable in response to at least one characteristic associated with the online user;
receiving first build data to generate a first variation of the advertisement, wherein the at least one component of the first variation of the advertisement is configured in response to a first defined characteristic inputted by a reviewer;
generating the first variation of the advertisement;
receiving second build data to generate a second variation of the advertisement, wherein the at least one component of the second variation of the advertisement is configured in response to a second defined characteristic inputted by the reviewer;
generating the second variation of the advertisement;
presenting to the user interface the first and second variations of the advertisement for selective display to the reviewer; and
storing the first and second build data associated with the generation of the first and second variations of the advertisement to enable subsequent regeneration of the first and second variations of the advertisement.

2. A computer-implemented method in accordance with claim 1, wherein at least one component of the advertisement is configurable in response to at least one characteristic associated with an advertiser.

3. A computer-implemented method in accordance with claim 2, said method further comprising:
receiving a selection from the reviewer of at least one item of build data associated with a characteristic of at least one of the online user and the advertiser; and
maintaining the at least one selected item of build data constant during generation of a plurality of variations of the advertisement.

4. A computer-implemented method in accordance with claim 1, said method further comprising generating a display on the user interface, the display including a simultaneous presentation of the first and second variations of the advertisement.

5. A computer-implemented method in accordance with claim 4, wherein the first and second variations of the advertisement are presented in a side-by-side format.

6. A computer-implemented method in accordance with claim 4, wherein the first and second variations of the advertisement are presented in a stacked format.

7. A computer-implemented method in accordance with claim 1, said method further comprising assigning a security level to the stored first and second build data.

8. Computer-readable storage media having computer-executable instructions embodied thereon, wherein, when executed by at least one processor, the computer-executable instructions cause the processor to:
retrieve from the memory device a stored template for an advertisement, wherein when displayed to an online user, at least one component of the advertisement is configurable in response to at least one characteristic associated with the online user;
receive first build data to generate a first variation of the advertisement, wherein the at least one component of the advertisement is configured in response to a first defined characteristic inputted by a reviewer;
generate the first variation of the advertisement;
receive second build data to generate a second variation of the advertisement, wherein the at least one component of the advertisement is configured in response to a second defined characteristic inputted by a reviewer;
generate the second variation of the advertisement;
present to the user interface the first and second variations of the advertisement for selective display to the reviewer; and
store the first and second build data associated with the generation of the first and second variations of the advertisement to enable subsequent regeneration of the first and second variations of the advertisement.

9. The computer-readable storage media in accordance with claim 8, wherein at least one component of the advertisement is configurable in response to at least one characteristic associated with an advertiser.

10. The computer-readable storage media in accordance with claim 9, wherein the computer-executable instructions cause the processor to:
receive a selection from the reviewer of at least one item of build data associated with a characteristic of at least one of an online user and the advertiser; and
maintain the at least one selected item of build data constant during generation of a plurality of variations of the advertisement.

11. The computer-readable storage media in accordance with claim 8, wherein the computer-executable instructions cause the processor to generate a display on the user interface, the display including a simultaneous presentation of the first and second variations of the advertisement.

12. The computer-readable storage media in accordance with claim 11, wherein the first and second variations of the advertisement are presented in a side-by-side format.

13. The computer-readable storage media in accordance with claim 12, wherein the first and second variations of the advertisement are presented in a stacked format.

14. The computer-readable storage media in accordance with claim 8, wherein the computer-executable instructions cause the processor to assign a security level to the stored first and second build data.

15. A computer system comprising:
a processor; and
a computer-readable storage device having encoded thereon computer readable instructions that are executable by the processor to perform functions comprising:
retrieving from the memory device a stored template for an advertisement, wherein when displayed to an online user, at least one component of the advertisement is configurable in response to at least one characteristic associated with the online user;
receiving first build data to generate a first variation of the advertisement, wherein the at least one component of the advertisement is configured in response to a first defined characteristic inputted by a reviewer;
generating the first variation of the advertisement;
receiving second build data to generate a second variation of the advertisement, wherein the at least one component of the advertisement is configured in response to a second defined characteristic inputted by the reviewer;
generating the second variation of the advertisement;
presenting to the user interface the first and second variations of the advertisement for selective display to the reviewer; and
storing the first and second build data associated with the generation of the first and second variations of the advertisement to enable subsequent regeneration of the first and second variations of the advertisement.

16. The computer system in accordance with claim 15, wherein at least one component of the advertisement is configurable in response to at least one characteristic associated with an advertiser.

17. The computer system in accordance with claim 16, wherein the processor is configured to:
receive a selection from the reviewer of at least one item of build data associated with a characteristic of at least one of an online user and the advertiser; and
maintain the at least one selected item of build data constant during generation of a plurality of variations of the advertisement.

18. The computer system in accordance with claim 15, wherein the processor is configured to generate a display on the user interface, the display including a simultaneous presentation of the first and second variations of the advertisement.

19. The computer system in accordance with claim 18, wherein the first and second variations of the advertisement are presented in a side-by-side format.

20. The computer system in accordance with claim 18, wherein the first and second variations of the advertisement are presented in a stacked format.

21. The computer system in accordance with claim 15, wherein the processor is configured to assign a security level to the stored first and second build data.
